(19) United States
(12) Patent Application Publication
(10) Pub. No.: US 2023/0368323 A1
(43) Pub. Date: Nov. 16, 2023

(54) INFORMATION PROCESSING APPARATUS, INFORMATION PROCESSING METHOD, AND NON-TRANSITORY COMPUTER-READABLE STORAGE MEDIUM

(71) Applicant: NEC Corporation, Minato-ku, Tokyo (JP)

(72) Inventors: Daisuke KOMAGOME, Tokyo (JP); Takahiro NISHI, Tokyo (JP); Yumi OGURA, Tokyo (AD)

(73) Assignee: NEC Corporation, Minato-ku, Tokyo (JP)

(21) Appl. No.: 18/026,995

(22) PCT Filed: Sep. 28, 2020
(86) PCT No.: PCT/JP2020/036659

§ 371 Date: Mar. 17, 2023

(51) Int. Cl. G06Q 50/30; G06Q 20/32; G06Q 20/38; G06F 3/0482

(52) U.S. Cl. CPC G06Q 50/30; G06Q 20/3267; G06Q 20/389; G06F 3/0482

(57) ABSTRACT

A server (100) includes a storage control unit (102) causing a ticket to be stored in association with service information that can be received when the ticket is purchased and a display control unit (104) causing a display unit to display a screen for accepting an operation by a user, wherein the display control unit (104) causes a display unit to display a selection screen for accepting selection of the service information associated with the ticket when accepting selection of the ticket as a purchase target, and computes a settlement amount of the selected service information and the selected ticket and causes the display unit to display a settlement amount screen, and, after completion of a settlement procedure for the settlement amount, the storage control unit (102) causes the ticket and the service information for which the settlement procedure is completed to be stored in association with the user.

### TECHNICAL FIELD

The present invention relates to an information processing apparatus, an information processing method, and a program and particularly relates to an information processing apparatus, an information processing method, and a program that support sale and use of tickets.

### BACKGROUND ART

Efforts related to mobility as a service (MaaS) have been actively made in recent years with innovation in digital technologies, change from possession to use, rise of new mobility services, and the like as a background.

Patent Document 1 describes a system performing route guidance in consideration of information about a free pass held by a user. The free pass refers to a pass that can be used free of charge in a predetermined region or section within a predetermined term of validity, and the pass is associated with attendant information allowing receipt of a preferential treatment such as a discount or no charge at a restaurant or the like. The document describes that free pass information may be electronically recorded in a memory in a terminal apparatus of a user, such as a smartphone.

Further, use of cashless payment using a smartphone of a user has been promoted in recent years. Patent Document 2 describes a configuration of giving benefits to a user who uses code payment and transmitting information about the benefits to a user terminal. Use of the benefits is accepted by depression of a use button, and the benefit information is embedded in code information. Thus, information about the benefits used by the user can be acquired by reading a code by a POS terminal in a store at code payment. Patent Document 3 describes an electronic ticketing system using a two-dimensional code.

### RELATED DOCUMENTS

### Patent Documents

Patent Document 1: Japanese Patent Application Publication No. 2020-030838
Patent Document 2: Japanese Patent Application Publication No. 2019-113924
Patent Document 3: Japanese Patent Application Publication No. 2002-183769

### SUMMARY OF INVENTION

### Technical Problem

However, the technologies described in the aforementioned documents do not allow a user to perform combined purchase and use of tickets and/or services allowing use of different transportation systems and/or a plurality of facilities, in a specific area.

The present invention has been made in view of the aforementioned circumstances, and an object of the present invention is to support sale and use of a ticket allowing use of a plurality of transportation systems and/or facilities run by operators of different businesses.

### Solution to Problem

In order to solve the aforementioned issue, the following configurations are employed in aspects of the present invention, respectively.

A first aspect relates to an information processing apparatus.

The information processing apparatus according to the first aspect includes:
a storage control unit that causes a ticket to be stored in association with service information that can be received when the ticket is purchased; and
a display control unit that causes a display unit to display a screen for accepting an operation by a user, wherein
the display control unit
   causes the display unit to display a selection screen for accepting selection of the service information associated with the ticket when accepting selection of the ticket as a purchase target and
   computes a settlement amount of the selected service information and the selected ticket and causes the display unit to display a settlement amount screen, and,
after completion of a settlement procedure for the settlement amount, the storage control unit causes the ticket and the service information for which the settlement procedure is completed to be stored in association with the user.

A second aspect relates to an information processing method executed by at least one computer.

An information processing method according to the second aspect includes, by an information processing apparatus:
causing a storage apparatus to store a ticket in association with service information that can be received when the ticket is purchased;
causing a display unit to display a selection screen for accepting selection of the service information associated with the ticket when accepting selection of the ticket as a purchase target;
computing a settlement amount of the selected service information and the selected ticket and causing the display unit to display a settlement amount screen; and,
after completion of a settlement procedure for the settlement amount, causing the ticket and the service information for which the settlement procedure is completed to be stored in association with a user.

Note that another aspect of the present invention may be a program causing at least one computer to execute the method according to the aforementioned second aspect, or a computer-readable storage medium on which such a program is recorded. The storage medium includes a non-transitory tangible medium.

The computer program includes a computer program code causing a computer to implement the information processing method on an information processing apparatus when being executed by the computer.

Note that any combination of the components described above, and representations of the present invention converted between a method, an apparatus, a system, a storage medium, a computer program, and the like are also valid as embodiments of the present invention.

Further, various components of the present invention do not necessarily need to be individually independent, and for example, a plurality of components may be formed as a single member, a plurality of members may form a single component, a certain component may be part of another component, and part of a certain component may overlap with part of another component.

Further, while a plurality of procedures are described in a sequential order in the method and the computer program according to the present invention, the order of description does not limit the order in which the plurality of procedures are executed. Therefore, when the method and the computer program according to the present invention are implemented, the order of the plurality of procedures may be changed without affecting the contents.

Furthermore, a plurality of procedures in the method and the computer program according to the present invention are not limited to be executed at timings different from each other. Therefore, for example, a certain procedure may be executed during execution of another procedure, and an execution timing of a certain procedure and an execution timing of another procedure may overlap with each other in part or in whole.

### Advantageous Effects of Invention

Each of the aforementioned aspects can support sale and use of a ticket allowing use of a plurality of transportation systems and/or facilities run by operators of different businesses.

### BRIEF DESCRIPTION OF THE DRAWINGS

FIG. 1 It is a diagram for illustrating a system overview of a digital ticketing system according to an example embodiment of the present invention.

FIG. 2 It is a diagram illustrating a data structure example of user account information.

FIG. 3 It is a block diagram illustrating a hardware configuration of a computer providing a server in FIG. 1.

FIG. 4 It is a functional block diagram logically illustrating a configuration of the server according to the present example embodiment.

FIG. 5 It is a diagram illustrating a data structure example of ticket information.

FIG. 6 It is a diagram illustrating data structure examples of ticket information and service information.

FIG. 7 It is a flowchart illustrating an operation example of the server related to ticket purchase.

FIG. 8 It is a diagram illustrating screen examples displayed on a user terminal when a ticket purchase procedure is performed.

FIG. 9 It is a diagram illustrating an example of an option selection screen.

FIG. 10 It is a diagram illustrating an example of a purchased ticket listing screen.

FIG. 11 It is a diagram illustrating a data structure example of ticket purchase information.

FIG. 12 It is a functional block diagram illustrating a functional configuration example of a server according to the present example embodiment.

FIG. 13 It is a flowchart illustrating an operation example of the server when ticket validity determination is performed.

FIG. 14 It is a diagram illustrating a data structure example of ticket information set with a term of validity from a start of ticket use.

FIG. 15 It is a diagram illustrating a data structure example of ticket purchase information when use of the ticket is started.

FIG. 16 It is a functional block diagram illustrating a functional configuration example of a server according to the present example embodiment.

FIG. 17 It is a diagram illustrating screen examples displayed on a user terminal when a ticket is used.

FIG. 18 It is a flowchart illustrating an operation example of the server in a case of entrance with a user terminal of a user displaying a QR code (registered trademark).

FIG. 19 It is a flowchart illustrating an operation example of the server in a case of entrance with a QR code posted on a facility being read by a user terminal of a user.

FIG. 20 It is a functional block diagram illustrating a functional configuration example of a server according to the present example embodiment.

FIG. 21 It is a diagram illustrating an example of a ticket listing screen for management.

FIG. 22 It is a diagram illustrating an example of a ticket editing screen for management.

### EXAMPLE EMBODIMENT

Example embodiments of the present invention will be described below by using drawings. Note that, in every drawing, similar components are given similar signs, and description thereof is not included as appropriate.

In the example embodiments, “acquisition” includes at least either of an apparatus getting data or information stored in another apparatus or a storage medium (active acquisition), and an apparatus inputting data or information output from another apparatus to the apparatus (passive acquisition). Examples of the active acquisition include making a request or an inquiry to another apparatus and receiving a response, and readout by accessing another apparatus or a storage medium. Further, examples of the passive acquisition include reception of distributed (or, for example, transmitted or push notified) information. Furthermore, “acquisition” may refer to acquisition by selection from received data or information, or selective reception of distributed data or information.

### First Example Embodiment

### <System Overview>

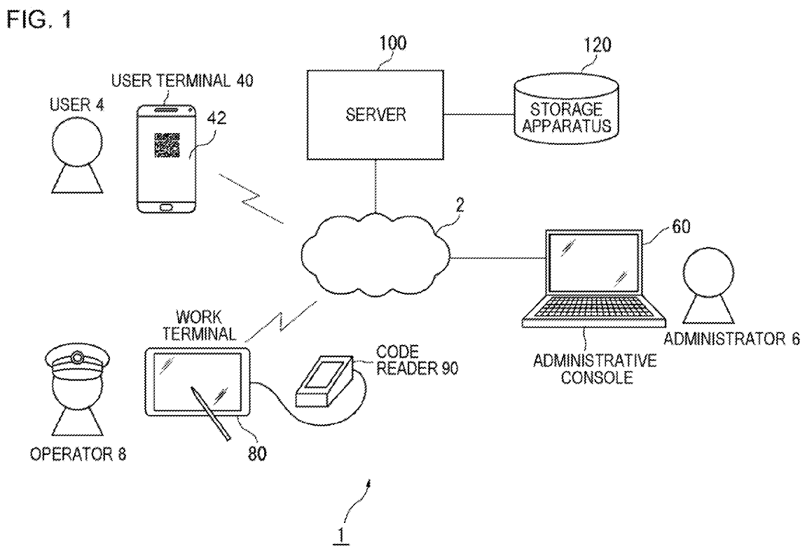

FIG. 1 is a diagram for illustrating a system overview of a digital ticketing system 1 according to an example embodiment of the present invention. The digital ticketing system 1 allows a user (also referred to as a user 4) to purchase a ticket for a transportation system in a specific region by using a user terminal 40 such as a smartphone and provides the user with services such as a discount on an admission ticket for a tourist facility in the region and presentation of a souvenir. The digital ticketing system 1 provides a service allowing a specially planned one-day ticket (one-day free pass) allowing combined use of a plurality of transportation systems such as a railroad, a bus, and a ferryboat to be purchased further in combination with a discount admission ticket for a tourist facility in the region. In the following description, the former ticket is also referred to as a “main ticket,” and the latter service is also referred to as an “optional ticket.”

The digital ticketing system 1 includes a server 100. The server 100 includes a storage apparatus 120. Note that the storage apparatus 120 may be an apparatus separate from the server 100, may be an apparatus included in the server 100, or may be a combination of the two.

A crew member of a transportation system, an employee of a tourist facility, or the like (indicated as an operator 8 in the diagram) manages entrance and exit of the user 4 by visually observing a ticket or an admission ticket provided by the user 4 or reading a two-dimensional code such as a QR code (registered trademark), by using a work terminal 80 such as a tablet terminal and a code reader 90.

A ticket purchased by the user 4 can be output to a touch panel 42 on the user terminal in a usable state. For example, a ticket face of the purchased ticket may be displayed on the touch panel 42 on the user terminal 40 and be presented to the operator 8; and the operator 8 may confirm the ticket face by visual observation. Alternatively, a QR code in which information about the purchased ticket is recorded may be displayed on the touch panel 42 on the user terminal 40 and be read by the code reader 90 by holding the ticket up to the code reader 90. Details will be described in a third example embodiment to be described later.

An administrator 6 of the digital ticketing system 1 can make various settings on the digital ticketing system 1, such as a setting of a use condition of a specially planned ticket by using an administrative console 60 such as a personal computer.

For example, the digital ticketing system 1 may be constructed on a platform of a cloud computing service. By using the cloud computing service, the digital ticketing system 1 can provide a function of constructing, managing, and distributing a content of a website accessed by the user terminal 40, the administrative console 60, and the work terminal 80 that are connected through a network 2 such as the Internet, data management function of the digital ticketing system 1, a transmission-reception function of mails (or messages) between each terminal and the server 100, and the like. Furthermore, the digital ticketing system 1 may be able to perform payment processing of a ticket purchased by the user 4 in coordination with an external payment substituting system.

According to the present example embodiment, when the user 4 logs into a predetermined website through a browser by using the user terminal 40, the digital ticketing system 1 starts providing a service. According to another example embodiment, an application program may be installed on the user terminal 40 of the user 4, and the user may log into the server 100 using the application. In the following description, the former configuration of accessing a website will be described.

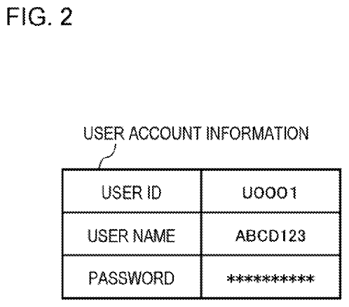

In an authentication procedure for logging in from the user terminal 40 to the digital ticketing system 1, account information acquired by previously performing user registration may be used, or user account information of another social networking service (SNS) may be used. FIG. 2 is a diagram illustrating a data structure example of user account information 160. The user account information 160 stores identification information (user ID), an account name, and a password for each user 4.

The server 100 includes an authentication unit (unillustrated) accepting input of account information of a user 4 as a login request to the digital ticketing system 1 and performing authentication processing, based on information in the user account information 160. When one user 4 successfully logs in, the authentication unit preferably does not accept another session until the user 4 logs out or until the session is automatically interrupted due to elapse of a predetermined time (for example, by time-out processing when there is no response for a predetermined time or longer). Therefore, for example, the authentication unit may surveille a session ID assigned for each login request. When a login request to an account of one user 4 is received from another terminal while ticket purchase processing is performed with the account of the one user 4, the session ID changes. When detecting change in the session ID of the account of the one user 4 while the ticket purchase processing is performed with the account, the authentication unit may assume that the login by the session ID is a login from another terminal and reject the later accepted login request. Further, the operation of the authentication unit is not limited to the above. For example, when receiving a login request to the account of the one user 4 from another terminal while ticket purchase processing is performed with the account of the one user 4, the authentication unit may accept the login request from the another terminal and cause the former logged-in terminal to forcibly log out.

### Hardware Configuration Example

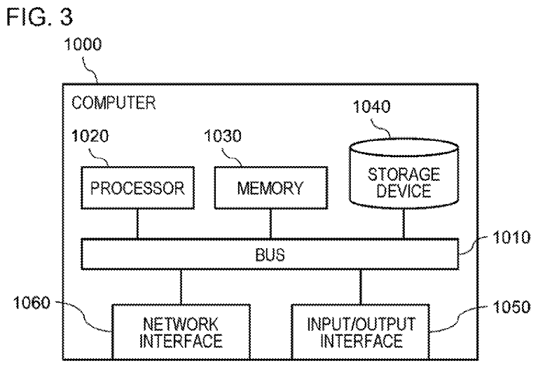

FIG. 3 is a block diagram illustrating a hardware configuration of a computer 1000 providing the server 100 in FIG. 1. The user terminal 40, the administrative console 60, and the work terminal 80 in FIG. 1 are also provided by the computer 1000.

The computer 1000 includes a bus 1010, a processor 1020, a memory 1030, a storage device 1040, an input-output interface 1050, and a network interface 1060.

The bus 1010 is a data transmission channel for the processor 1020, the memory 1030, the storage device 1040, the input-output interface 1050, and the network interface 1060 to transmit and receive data to and from one another. Note that the method for interconnecting the processor 1020 and other components is not limited to a bus connection.

The processor 1020 is a processor provided by a central processing unit (CPU), a graphics processing unit (GPU), or the like.

The memory 1030 is a main storage provided by a random-access memory (RAM) or the like.

The storage device 1040 is an auxiliary storage provided by a hard disk drive (HDD), a solid-state drive (SSD), a memory card, a read-only memory (ROM), or the like. The storage device 1040 stores program modules providing functions of the server 100 (such as a control unit 101, a storage control unit 102, a display control unit 104, a determination unit 106, an acceptance unit 110, and a setting unit 112 to be described later). By reading each program module into the memory 1030 and executing the program module by the processor 1020, each function related to the program module is provided. Further, the storage device 1040 may also store data in the storage apparatus 120 in the server 100.

A program module may be recorded on a storage medium. The storage medium on which the program module is recorded includes a non-transitory tangible medium usable by the computer 1000; and a program code readable by the computer 1000 (processor 1020) may be embedded in the medium.

The input-output interface 1050 is an interface for connecting the computer 1000 to several types of input-output equipment. The input-output interface 1050 also functions as a communication interface performing short-distance wireless communication such as Bluetooth (registered trademark) and/or near field communication (NFC).

The network interface 1060 is an interface for connecting the computer 1000 to a communication network. Examples of the communication network include a local area network (LAN) and a wide area network (WAN). The method for connecting the network interface 1060 to the communication network may be a wireless connection or a wired connection.

Then, the computer 1000 is connected to required equipment (such as output apparatuses such as a display, input apparatuses such as a touch panel, a keyboard, and a mouse, a camera, a speaker, and a microphone in the user terminal 40, the administrative console 60, and the work terminal 80, and the code reader 90 connected to the work terminal 80) through the input-output interface 1050 or the network interface 1060.

### Functional Configuration Example

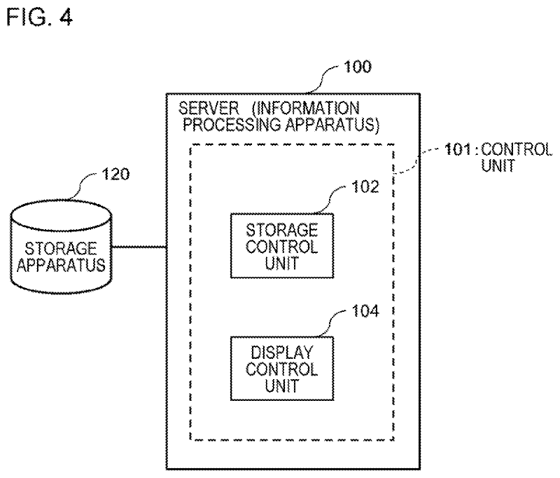

FIG. 4 is a functional block diagram logically illustrating a configuration of the server 100 according to the present example embodiment.

The server 100 includes a control unit 101. The control unit 101 may include a storage control unit 102 and a display control unit 104.

The storage control unit 102 causes the storage apparatus 120 to store a ticket in association with service information that can be received when the ticket is purchased.

The display control unit 104 causes a display unit (such as the touch panel 42 on the user terminal 40) to display a screen for accepting a user operation.

A ticket is a ticket or a boat ticket for a transportation system such as a railroad, a bus, and a ferryboat and may be a ticket for a single transportation system or a ticket allowing use of a plurality of transportation systems. The number of days, time, the number of times, and/or the like allowed for use is preset to a ticket. For example, a free ticket allowing use of the ticket as many times as desired until after a predetermined days or predetermined hours from the start of use, such as a one-day free pass, a half-day free pass, an eight-hour free pass, a 48-hour free pass, and a 72-hour free pass, a coupon ticket allowing the ticket to be used N times during predetermined days after purchase, such as an N-time ticket, and the like can be set. Various settings related to a ticket can be made by using the administrative console 60. Setting of a ticket will be described in a fourth example embodiment to be described later.

As described above, a ticket may combine use of a plurality of transportation systems and for example, may include a ticket combining use of a plurality of usable railroad and bus routes and usable ferryboat sea routes. A fare of each ticket may have a price discounted from a regular ticket fare. A price of a ticket may also be set by using the administrative console 60.

Service information refers to information about a service that can be additionally purchased or used as an option when a ticket is purchased. For example, the service refers to a service allowing a ticket for an express bus from a certain station or a certain bus stop on a route included in a purchased ticket to an airport, an admission ticket for a tourist facility in the vicinity of a route included in a purchased ticket, a discount ticket for a ropeway, a cable car, or the like, a boat ticket for a pleasure boat, a ferryboat, or the like, a pass for a parking lot, a coupon usable at a specific store, and/or the like to be purchased at a discount price or be received free of charge.

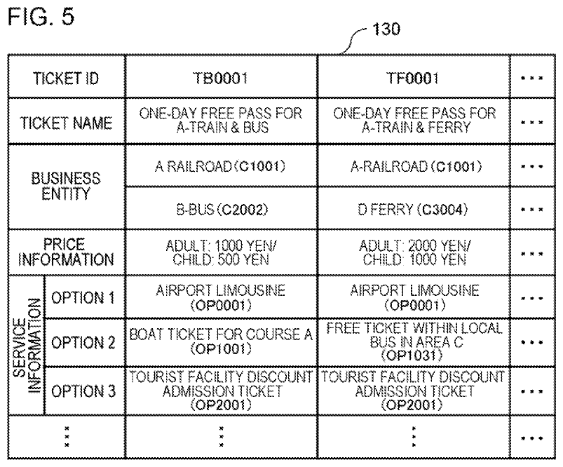

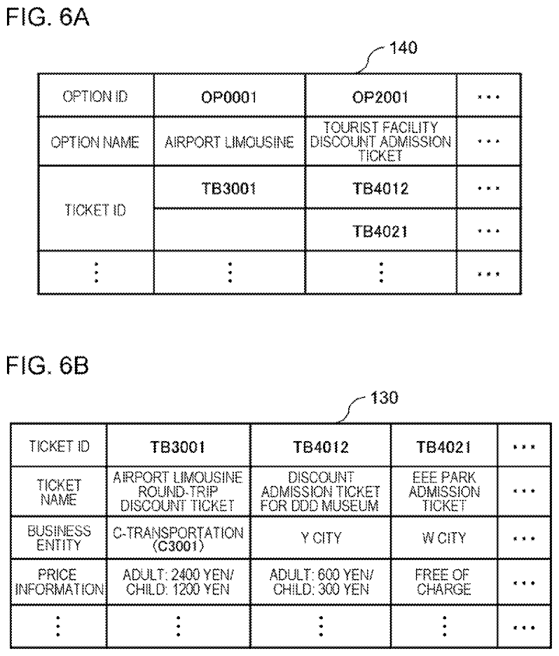

FIG. 5 is a diagram illustrating a data structure example of ticket information 130. For each ticket, the ticket information 130 is associated with information about a service that can be additionally purchased or used as an option when the ticket is purchased. In this example, the ticket information includes information such as identification information of a ticket (ticket ID), the name of the ticket (ticket name), identification information of at least one operator of business entity being a seller of the ticket (such as identification information of an operator of a railroad, a bus, or a ferryboat), and a selling price of the ticket for each category (a category such as adult, student, child, handicapped person, or license surrenderer only). The service information includes information about at least one optional service. In this example, a ticket is associated with information about three services (options 1 to 3) that can be used or purchased when the ticket is purchased. Each option in the service information is assigned with an option ID (service information 140 in FIG. 6), and the service information can be associated with the ticket (ticket ID) in FIG. 5 by an option ID.

FIG. 6(a) is a diagram illustrating a data structure example of service information 140 associated with the ticket information in FIG. 5. As illustrated in FIG. 6(a), the service information (optional ticket) includes a second ticket (ticket information 130 in FIG. 6(b)) different from the ticket in FIG. 5. FIG. 6(b) is a diagram illustrating a data structure example of at least one piece of ticket information 130 associated with the service information 140 in FIG. 6(a). In a case of a main ticket, the ticket information 130 is associated with an optional ticket (service information) that can be purchased together with the main ticket, as illustrated in FIG. 5. On the other hand, in a case of an optional ticket, the ticket information 130 is not associated with an optional ticket (service information), as illustrated in FIG. 6(b).

For each optional ticket (service information), the service information 140 in FIG. 6(a) is associated with identification information (option ID), the name of the option (option name), and at least one ticket. In other words, an optional ticket may be associated with a plurality of tickets; and service information is hereinafter also referred to as an “option group.”

In this example, an option group of an airport limousine ticket with an option ID “OP0001” includes a round-trip discount ticket for an airport limousine bus with a ticket ID “TB3001.” An option group of a tourist facility discount admission ticket with an option ID “OP2001” includes two tickets being a discount admission ticket for a museum with a ticket ID “TB4012” and an admission ticket for a park with a ticket ID “TB4021.”

### Operation Example

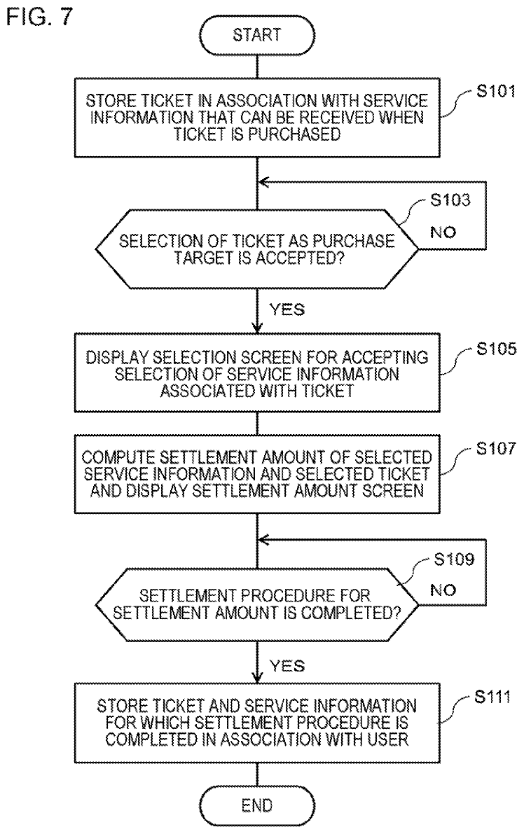

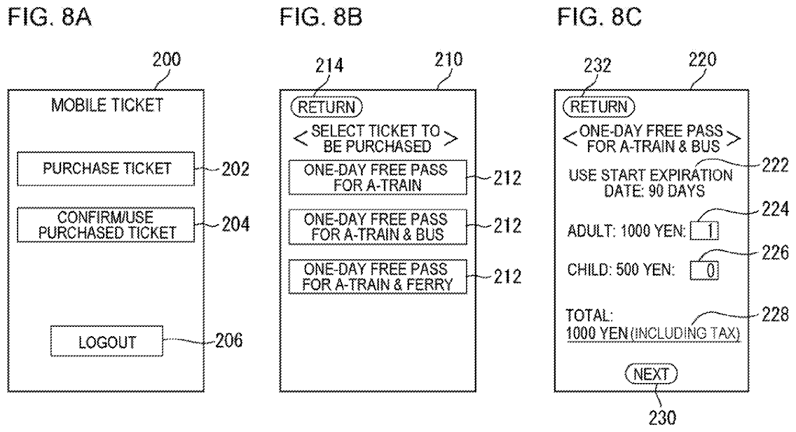

FIG. 7 is a flowchart illustrating an operation example of the server 100 related to ticket purchase. FIG. 8 to FIG. 10 are diagrams illustrating screen examples displayed on the user terminal 40 during a ticket purchase procedure.

First, the storage control unit 102 causes the storage apparatus 120 to store a ticket associated with service information that can be received when the ticket is purchased as ticket information 130 (FIG. 5) (Step S101). Furthermore, the storage control unit 102 also causes the storage apparatus 120 to store the service information 140 in FIG. 6(a) and ticket information 130 of the optional ticket in FIG. 6(b).

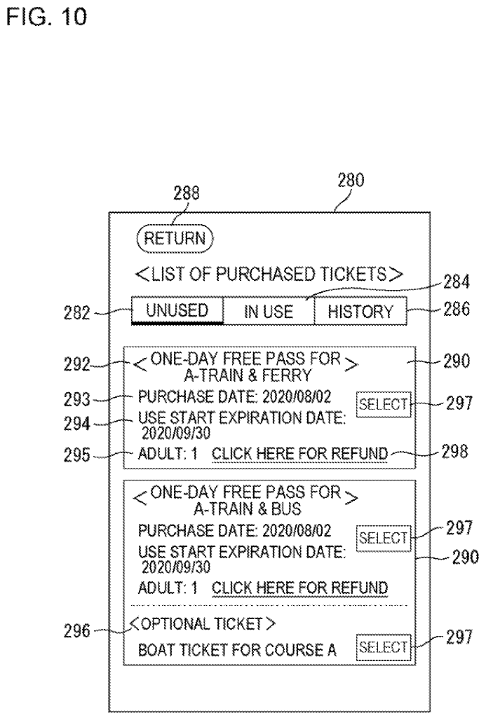

FIG. 8(a) is a diagram illustrating an example of a menu screen 200. The menu screen 200 is displayed when a user 4 starts a browser on the user terminal 40, accesses a predetermined uniform resource locator (URL), and logs into the digital ticketing system 1. The menu screen 200 includes a ticket purchase button 202, a purchased ticket confirmation-use button 204, and a logout button 206. When accepting depression of the ticket purchase button 202, the display control unit 104 causes the touch panel 42 on the user terminal 40 to display a ticket selection screen 210 in FIG. 8(b). When accepting depression of the purchased ticket confirmation-use button 204, the display control unit 104 causes the touch panel 42 on the user terminal 40 to display a purchased ticket listing screen 280 in FIG. 10. The purchased ticket listing screen 280 will be described later. When accepting depression of the logout button 206, a logout from the digital ticketing system 1 is performed, and the display control unit 104 closes the menu screen 200.

The ticket selection screen 210 in FIG. 8(b) includes at least one ticket purchase button 212 and a return button 214. When accepting depression of the return button 214, the display control unit 104 returns the display screen from the ticket selection screen 210 to the menu screen 200.

While three ticket purchase buttons 212 are displayed in the ticket selection screen 210 in this example, the display is not limited thereto. Further, a user interface (UI) (such as a check button, a radio button, a drum roll, a pull-down menu, an icon, and a tab) allowing specification of a type of ticket that can be purchased on the ticket selection screen 210 may be included. For example, a time-limited ticket, an area-limited ticket, a transportation-system-limited ticket, and a regular ticket may be selected.

The user 4 selects a “main ticket” being a purchase target. When accepting depression of a ticket purchase button 212, the display control unit 104 causes the touch panel 42 on the user terminal 40 to display a quantity specification screen 220 (FIG. 8(c)) for a selected ticket corresponding to the depressed ticket purchase button 212.

As illustrated in FIG. 8(c), the quantity specification screen 220 includes quantity input parts 224 and 226 for accepting specification of purchased quantities of a ticket selected on the ticket selection screen 210, an expiration date display part 222 indicating an expiration date of the ticket, an amount display part 228 indicating the total amount for the specified quantities, and a next button 230 for advancing to a next procedure after quantity specification.

For example, the quantity input parts 224 and 226 may be text boxes, drum rolls, or lists. In the quantity specification screen 220 in this example, the quantity input parts 224 and 226 include two input parts for adult and child but are not limited thereto. An amount for one ticket for each category related to the ticket and an input field are displayed. For example, when a student discount ticket is available, an amount for one student discount ticket and an input field for a quantity may be further displayed. Alternatively, for a ticket without distinction between adult and child, an amount for one person and an input field for a quantity may only be displayed.

Further, with regard to price information of a ticket with a discount amount, an amount before discount, a discount rate, and/or the like may be displayed together with the price information. The total amount displayed in the amount display part 228 may be updated every time input to the quantity input parts 224 and 226 is finalized; or when depression of a recomputation button (unillustrated) is accepted, the total amount may be recomputed with quantities specified in the quantity input parts 224 and 226, and the display may be updated.

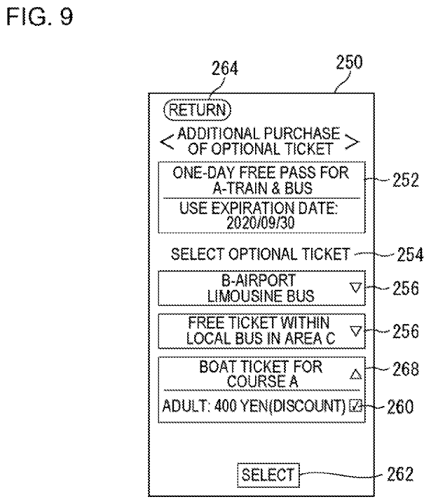

Returning to FIG. 7, when accepting selection of a ticket as a purchase target (YES in Step S103), the display control unit 104 causes the touch panel 42 to display a selection screen (an option selection screen 250 in FIG. 9) for accepting selection of service information associated with the selected ticket (Step S105).

FIG. 9 illustrates a display example of an option selection screen 250 when an “A train-bus one-day free pass” is selected in the ticket selection screen 210 in FIG. 8(b) and one adult is specified in the quantity specification screen 220 in FIG. 8(c). The option selection screen 250 includes a ticket expiration date display part 252, a message display part 254 prompting selection of service information, a selectable service information display part 256, a selected service information display part 258, an option selection specification checkbox 260, and a selection finalization button 262. In this example, an A course boat ticket is selected (the checkbox 260 is checked) is setted out of the three optional tickets.

When accepting depression of the selection finalization button 262 in a state of service information (optional ticket) to be purchased together with a ticket being selected as illustrated in FIG. 9, the display control unit 104 computes settlement amounts of the selected ticket and the selected service information and causes the touch panel 42 to display a settlement amount screen (unillustrated) (Step S107 in FIG. 7). Specifically, the settlement amount screen includes a purchase content for confirmation and a settlement amount. When accepting a finalization operation of the purchase content on the settlement amount screen, the display control unit 104 makes a transition to a payment procedure screen (unillustrated). For example, the payment procedure screen includes a UI for inputting information required for payment by a credit card and when accepting an operation of payment finalization, transfers the payment information to a system in an external payment substituting company. Alternatively, the payment processing may use a system environment of an external payment substituting company and when accepting the finalization operation, makes a transition to a payment procedure screen in a system in the external payment substituting company and completes the payment processing by the external system.

Then, after completion of the settlement procedure for the settlement amounts (YES in Step S109), the storage control unit 102 causes the storage apparatus 120 to store the ticket and the service information for which the settlement procedure is completed in association with a user as ticket purchase information 150 (Step S111). For example, completion of the settlement procedure can be determined by receiving a result of payment completion from the payment substituting system.

While a configuration of performing selection of service information (optional ticket) along with ticket purchase has been described above, service information (optional ticket) may be additionally purchased later for an unused ticket in another example.

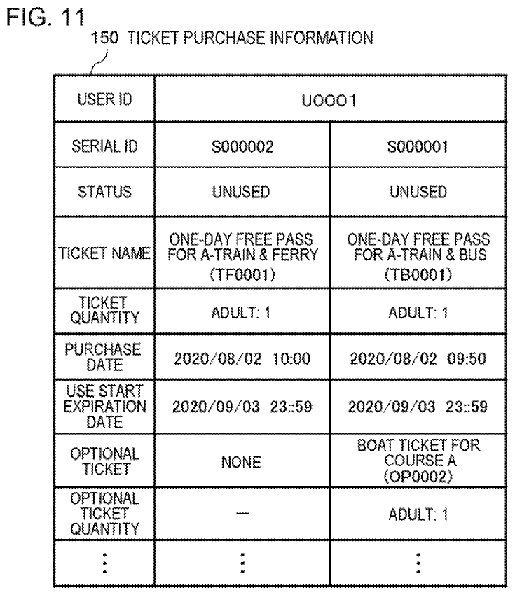

FIG. 11 is a diagram illustrating a data structure example of ticket purchase information 150. The ticket purchase information 150 stores information about a purchased ticket for each user 4. For example, a ticket purchased by a user 4 is assigned with a serial ID uniquely assigned to each ticket. Each piece of ticket purchase information 150 includes information indicating the current status of the ticket such as “unused,” “in use,” or “used.” Information about unused tickets is included in the example in FIG. 11. When the status of the ticket is changed, the storage control unit 102 updates the status of the ticket purchase information 150.

As described above, the storage control unit 102 in the server 100 according to the present example embodiment causes the storage apparatus 120 to store a ticket in association with service information that can be received when the ticket is purchased. Then, when accepting selection of a ticket being a purchase target, the display control unit 104 causes the user terminal 40 to display the option selection screen 250 for service information (optional ticket) associated with the ticket. Then, the display control unit 104 computes settlement amounts of the selected ticket (main ticket) and the selected optional ticket and causes the user terminal 40 to display the settlement amount screen. After completion of the settlement procedure, the storage control unit 102 stores the ticket (main ticket) and the optional ticket for which the settlement procedure is completed in association with each other into the ticket purchase information 150.

Thus, the server 100 according to the present example embodiment enables combined purchase of tickets for a plurality of transportation systems and/or facilities run by operators of different businesses with a simple operation. The ticket sales side can propose a plurality of tickets and/or services in combination to a user and therefore can provide the user with more attractive and appealing services.

Further, the configuration of allowing use of a service based on a login by inputting a user ID and a password to the digital ticketing system 1 from the user terminal 40 of a user 4 does not allow simultaneous use from a plurality of terminals and therefore can prevent improper use and duplicate purchase by mistake.

### Second Example Embodiment

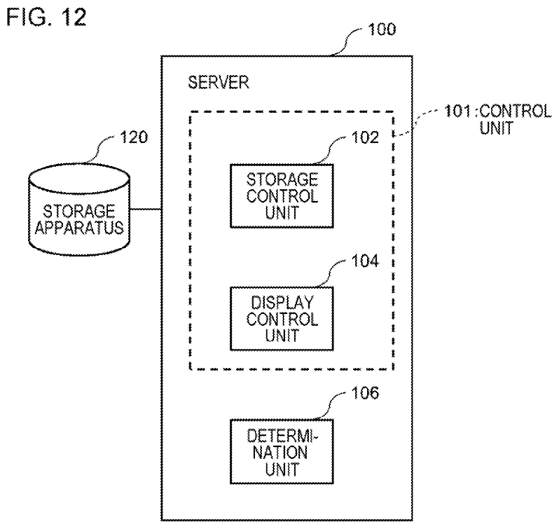

FIG. 12 is a functional block diagram illustrating a functional configuration example of a server 100 according to the present example embodiment.

The present example embodiment is similar to the aforementioned example embodiment except for being configured to set at least one of a term of validity and an allowable use count for each ticket and perform validity determination when a ticket is used. The server 100 illustrated in the diagram further includes a determination unit 106 in addition to the configuration of the server 100 according to the first example embodiment in FIG. 4. Note that the configuration according to the present example embodiment may be combined with the configuration according to at least one of the other example embodiments without contradicting each other.

When a ticket is used, the determination unit 106 performs validity determination of the ticket by setting a starting time of a term of validity of the ticket or counting a use count of the ticket.

Furthermore, when a ticket is associated with a term of validity, an allowable time frame for the start of use of the ticket is set. Then, the determination unit 106 further uses whether the current time is in the allowable time frame for the start of use of the ticket in the validity determination.

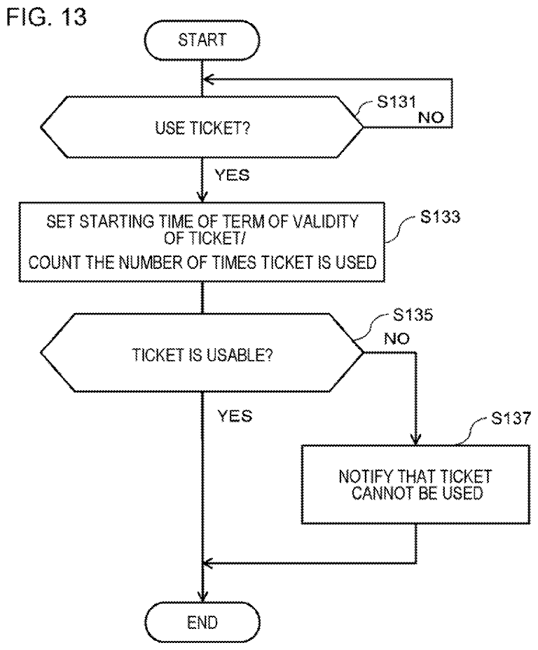

FIG. 13 is a flowchart illustrating an operation example of the server 100 when validity determination of a ticket is performed. When detecting use of a ticket (YES in Step S131), the determination unit 106 sets a starting time of a term of validity of the ticket or counts a use count of the ticket (Step S133). A procedure for the start of use of the ticket and a detection method for ticket use will be described in detail in the third example embodiment to be described later.

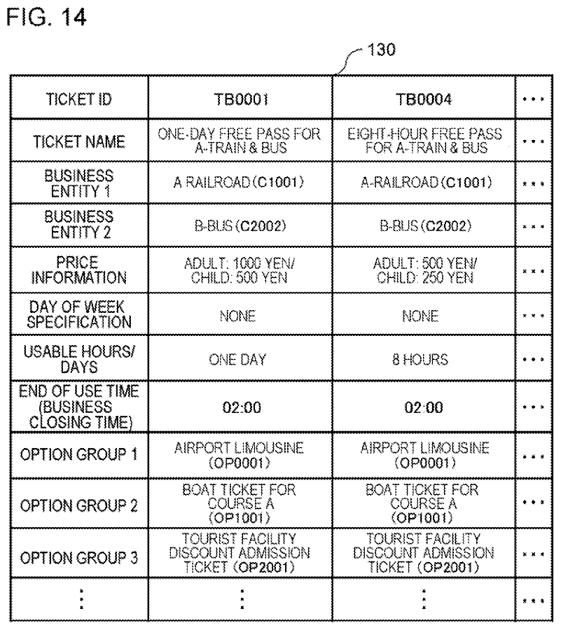

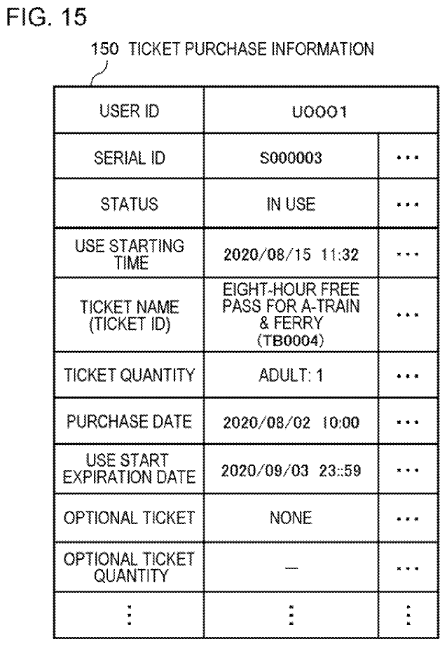

FIG. 14 is a diagram illustrating a data structure example of ticket information 130 in which a term of validity from the start of ticket use is set. FIG. 15 is a diagram illustrating a data structure example of ticket purchase information 150 when use of the ticket is started. The ticket purchase information 150 in FIG. 15 further includes information indicating the current status of the ticket in addition to the data structure of the ticket information 130.

The storage control unit 102 stores the use starting time set in Step S133 or the use count counted in Step S133 into the ticket purchase information 150. The use starting time is recorded in the example in FIG. 15. For example, when a 48-hour free pass or the like is used, different transportation systems are used a plurality of times, and the processing is executed for each use. Then, in Step S135 in FIG. 13, the determination unit 106 refers to the ticket purchase information 150 and determines whether the current time is within the term of validity of the ticket (48 hours) from the starting time of the term of validity of the ticket. Alternatively, the determination unit 106 determines whether the ticket is used beyond the use count.

When being within the term of validity or the use count, the ticket is determined usable. When the ticket is determined usable (YES in Step S135), the processing is ended. When the ticket is determined not usable (NO in Step S135), the display control unit 104 causes a touch panel 42 on a user terminal 40 to display a message notifying the user 4 that the ticket cannot be used (Step S137).

The server 100 may further include an output unit (unillustrated) causing a speaker (unillustrated) in the user terminal 40 to output an alarm or a voice and/or causing a vibrator in the user terminal 40 to output vibrations in addition to displaying a message.

As described above, when use of a ticket is started, the determination unit 106 in the server 100 according to the present example embodiment determines whether the ticket is usable and when the ticket is not usable, makes notification that the ticket cannot be used.

The configuration provides effects similar to those of the aforementioned example embodiment, enables accurate determination of a usable period, a use count limit, and the like varied for each ticket, and enables notification about the determination to a user.

### Third Example Embodiment

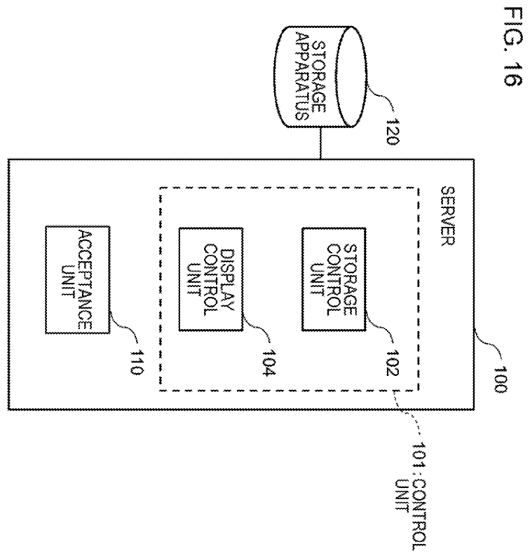

FIG. 16 is a functional block diagram illustrating a functional configuration example of a server 100 according to the present example embodiment. The present example embodiment is similar to one of the aforementioned example embodiments except that an acceptance method for a use start request is set for each ticket. The server 100 in FIG. 16 further includes an acceptance unit 110 in addition to the configuration of the server 100 according to the first example embodiment in FIG. 4. Note that the configuration according to the present example embodiment may be combined with the configuration according to at least one of the other example embodiments without contradicting each other.

The acceptance unit 110 accepts a use start request for a ticket. The acceptance unit 110 accepts a use start request for a ticket by an acceptance method related to each ticket.

FIG. 10 is a diagram illustrating an example of a purchased ticket listing screen 280. A user 4 can select a ticket to be used from a ticket list in the purchased ticket listing screen 280. The purchased ticket listing screen 280 includes an unused tab 282 for displaying a list of unused tickets, an in-use tab 284 for displaying a list of tickets in use, and a history tab 286 for displaying a list of used tickets. FIG. 10 illustrates a state of the unused tab 282 being selected, and detailed information about two tickets is displayed.

The purchased ticket listing screen 280 further includes a detailed ticket information display part 290 for each ticket. The detailed ticket information display part 290 includes a ticket name display part 292, a ticket purchase date display part 293, a use start expiration date display part 294, a ticket category-quantity display part 295, a ticket selection button 297, and a refund link 298.

When accepting depression of the refund link 298, the display control unit 104 makes a transition to a refund procedure screen (unillustrated). The refund procedure screen includes a UI providing the user 4 with a refund fee preset for each ticket and accepting an operation of finalizing execution of refund. When accepting the operation of finalizing execution of refund, the display control unit 104 transfers the settlement amount information to a payment substituting system performing a refund procedure and instructs the system to perform the refund procedure.

Furthermore, the purchased ticket listing screen 280 includes an optional ticket information display part 296 for a ticket associated with an option.

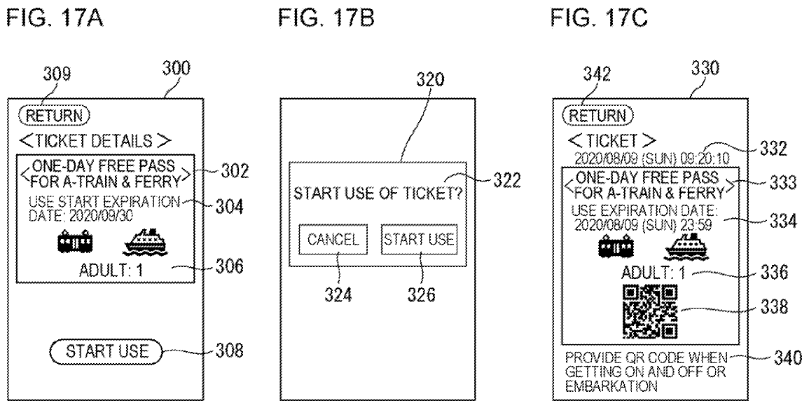

When using a ticket, the user 4 depresses a selection button 297 for the ticket to be used in the list of unused tickets. When accepting depression of the selection button 297, the display control unit 104 makes a transition to a detailed ticket screen 300 in FIG. 17(a).

FIG. 17 is a diagram illustrating a screen example displayed on a touch panel 42 on a user terminal 40 when a ticket is used. The detailed ticket screen 300 in FIG. 17(a) is a screen for indicating details of a ticket for which depression of a selection button 297 is accepted out of unused tickets in the purchased ticket listing screen 280 in FIG. 10. The detailed ticket screen 300 includes a detailed ticket information display part 302, a use start button 308, and a return button 309.

The detailed ticket information display part 302 includes the ticket name of a ticket selected for use, a use start expiration date (an expiration date display part 304), an icon indicating a target operator of business entity of the ticket (icons of a railroad and a ferryboat in this case), and a ticket target category-quantity 306 (one adult in this case). When accepting depression of the use start button 308, the display control unit 104 causes the touch panel 42 to display a use start screen 320 in FIG. 17(b) by pop-up. When accepting depression of the return button 309, the display control unit 104 returns the screen to the purchased ticket listing screen 280 in FIG. 10.

The use start screen 320 in FIG. 17(b) includes a display part 322 for displaying a message inquiring whether to start use of a ticket, a cancel button 324, and a use start button 326. When accepting depression of the cancel button 324, the display control unit 104 closes the use start screen 320 being displayed by pop-up and returns to the detailed ticket screen 300. When accepting depression of the use start button 326, the display control unit 104 causes the touch panel 42 to display a ticket face screen 330 in FIG. 17(c).

The ticket face screen 330 includes a use starting time display part 332, a ticket name display part 333, an expiration date display part 334, a ticket category-quantity display part 336, a QR code display part 338, and a ticket usage display part 340.

For example, the use starting time display part 332 displays the time when the use start button 326 in the use start screen 320 is depressed. The ticket name display part 333 displays the ticket name of a ticket use of which is started. The expiration date display part 334 displays an expiration date predetermined for each ticket. The ticket category-quantity display part 336 displays the category (such as adult or child) and a quantity of the ticket. The QR code display part 338 displays a QR code including information about the ticket. Details of a QR code will be described later. The ticket usage display part 340 displays a message indicating a ticket usage predetermined for each ticket.

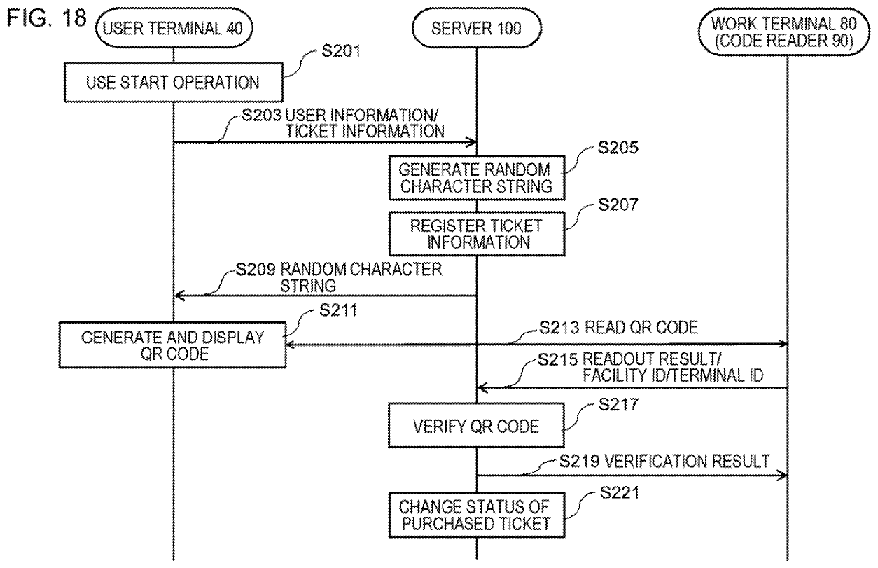

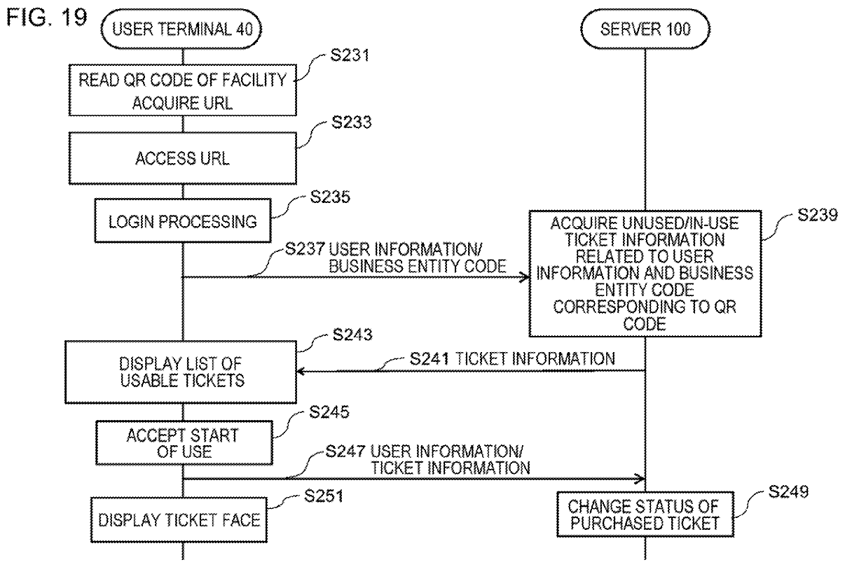

Examples of an acceptance method for a use start request for a ticket, the request being accepted by the acceptance unit 110, include the following but are not limited thereto.
(1) An operator 8 of a facility to be used confirms a ticket face of a ticket (main ticket) or service information (optional ticket) displayed on the user terminal 40 by visual observation. An animation or the like for preventing an improper act using a screenshot or the like may be displayed on a screen on which the ticket face is displayed together with an image of the ticket face.
(2) The user terminal 40 displays a QR code (registered trademark), and the QR code is read by a code reader 90 in a work terminal 80. The QR code includes ticket information (at least a user ID and a ticket ID). Details will be described later by using FIG. 18.
(3) A QR code provided on a facility to be used is read by using a camera on the user terminal 40. The QR code includes identification information of an operator of business entity of the facility to be used (such as a business entity code or a facility ID) and a URL to be accessed by the user terminal 40. Details will be described later by using FIG. 19.

When accepting a use start request by one of the aforementioned methods, the storage control unit 102 updates the status of the ticket in the ticket purchase information 150 from unused to in use. Furthermore, the storage control unit 102 stores the use starting time of the ticket into the ticket purchase information 150.

### Operation Example

An operation example of the server 100 related to the acceptance methods for a start of use in aforementioned (2) and (3) will be described below.

### <Entrance by Causing User Terminal 40 to Display QR Code>

FIG. 18 is a flowchart illustrating an operation example of the server 100 in a case of entrance by causing the user terminal 40 of a user 4 to display a QR code. The user terminal 40 is already logged into the digital ticketing system 1 with an account of the user 4, and the use start button 326 in the use start screen 320 (FIG. 17(b)) for a ticket selected in the purchased ticket listing screen 280 is depressed (Step S201). The user terminal 40 transmits the ticket ID (or the serial ID) of the ticket and the user ID of the user 4 to the server 100 (Step S203). At this time, the display control unit 104 causes the touch panel 42 on the user terminal 40 to display the ticket face screen 330 (FIG. 17(c)) without display of a QR code (QR code display part 338).

Then, the server 100 generates a random character string for QR code generation (Step S205). Then, the storage control unit 102 stores the random character string generated in Step S205 and expiration date information of a QR code into the ticket purchase information 150 in association with the user ID (Step S207). The server 100 transmits the generated random character string to the user terminal 40 (Step S209).

The user terminal 40 generates a QR code including the random character string received from the server 100 and causes the touch panel 42 to display the code (Step S211). When the QR code is read by the code reader 90 in the work terminal 80 by holding the code up to the code reader 90 (Step S213), the work terminal 80 returns the readout result, the identification information (facility ID) of a facility where the work terminal 80 is installed, and the identification information (terminal ID) of the work terminal 80 to the server 100 (Step S215).

The server 100 verifies the QR code, based on the readout result of the QR code by the work terminal 80, the result being received from the work terminal 80 (Step S217). When the verification result satisfies a criterion, the server 100 transmits the verification result to the work terminal 80 (Step S219). Then, the storage control unit 102 in the server 100 changes the status of the ticket in the ticket purchase information 150 from unused to in use (Step S221). Then, the user 4 is admitted. When the verification result does not satisfy the criterion, use of the ticket is not authenticated, and the user 4 cannot be admitted.

Furthermore, the display control unit 104 may cause the touch panel 42 to display a date of use and/or an expiration date of a ticket with admission. The operator 8 may confirm that the date of use and/or the like displayed on the user terminal 40 indicates the day to be used by visual observation.

Further, when accepting a use start operation of a ticket set with a usable period in a configuration combined with the aforementioned example embodiment, the determination unit 106 may determine whether the date and time when the use start operation is accepted is within a use start period before Step S205. When the date and time is within the usable period, the processing advances to Step S205. When the date and time is out of the usable period, the display control unit 104 may cause the user terminal 40 to display that the ticket is out of the usable period and end the flow.

### <Entrance by Reading QR Code Posted on Facility by User Terminal 40>

FIG. 19 is a flowchart illustrating an operation example of the server 100 in a case of entrance by reading, by the user terminal 40 of the user 4, a QR code posted on a facility. The user terminal 40 reads a QR code posted on a facility by using, for example, a camera and acquires a URL (Step S231). Then, the user terminal 40 accesses the acquired URL (Step S233) and logs into the digital ticketing system 1 (Step S235). Note that when the user terminal is already logged into the digital ticketing system 1, the login processing in Step S235 may be not included.

Then, the server 100 acquires user information (user ID) and a business entity code from the user terminal 40 (Step S237). Then, the server 100 extracts ticket information of a ticket related to the acquired business entity code from among unused and in-use tickets from ticket purchase information 150 for the acquired user ID (Step S239).

The display control unit 104 in the server 100 transmits the extracted ticket information of the ticket to the user terminal 40 (Step S241) and causes the touch panel 42 on the user terminal 40 to display a list display screen (unillustrated) for tickets usable at the facility (Step S243). The format of the screen may be similar to that of the purchased ticket listing screen 280 in FIG. 10.

Then, when depression of a selection button 297 for a ticket for the facility is accepted (Step S245), a use start screen (unillustrated) including a content of the ticket for which depression of the selection button 297 is accepted, a message confirming a start of use of the ticket, and a use start button is displayed. Then, when depression of the use start button in the screen is accepted, the server 100 acquires ticket information (at least a ticket ID or a serial ID) of the ticket and user information from the user terminal 40 (Step S247). The message confirming a start of use of the ticket may be displayed after depression of the use start button. The storage control unit 102 changes the status of the acquired ticket information from “unused” to “in use” (Step S249). Then, the display control unit 104 causes the touch panel 42 on the user terminal 40 to display a ticket face of the ticket (Step S251).

When the user 4 provides the ticket face displayed on the user terminal 40 for the operator 8, the operator 8 confirms the ticket face by visual observation, and the user 4 can enter the facility.

The acceptance unit 110 in the server 100 according to the present example embodiment accepts a use start request for a ticket by an acceptance method related to each ticket. For example, one of the following is predetermined for each ticket: (1) use is started by causing the user terminal 40 to display a QR code and reading the code by the code reader 90, (2) use is started by depressing the use start button 326 in the use start screen 320 by the user 4, and (3) use is started by reading a QR code posted on a facility.

The configuration provides effects similar to those of the aforementioned first example embodiment and further enables acceptance of a use start request by a method corresponding to an acceptance method for a use start request for a ticket, the acceptance method being varied for each facility. The function is highly convenient for both a user and the facility side.

### Fourth Example Embodiment

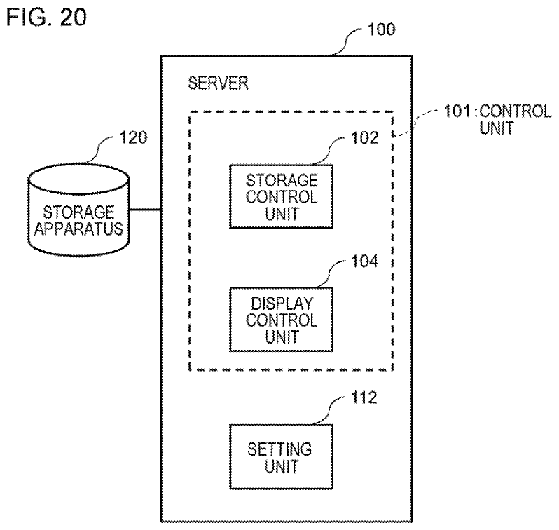

FIG. 20 is a functional block diagram illustrating a functional configuration example of a server 100 according to the present example embodiment. The present example embodiment is similar to one of the aforementioned example embodiments except for being configured to set association between a ticket and service information. The server 100 in FIG. 20 further includes a setting unit 112 in addition to the configuration of the server 100 according to the first example embodiment in FIG. 4. Note that the configuration according to the present example embodiment may be combined with the configuration according to at least one of the other example embodiments without contradicting each other.

The setting unit 112 sets association between a ticket and service information.

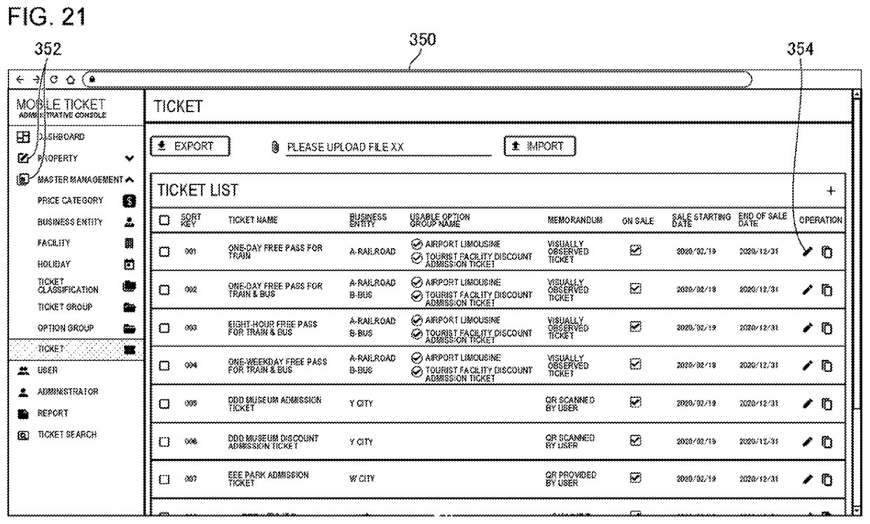

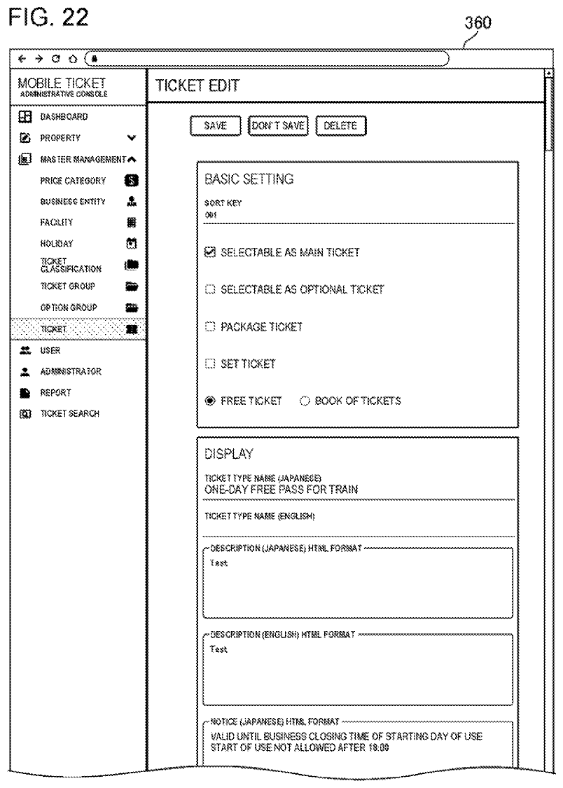

Specifically, the setting unit 112 causes an administrative console 60 operated by an administrator 6 to display a setting screen (FIG. 21 and FIG. 22) for performing association of a ticket with service information. Then, the setting unit 112 accepts a setting operation by the administrator 6, generates ticket information 130 and service information 140, and causes a storage apparatus 120 to store the pieces of information.

A ticket listing screen for management 350 in FIG. 21 includes a list of tickets being scheduled to be sold or on sale. Further, as illustrated in FIG. 21, various menus 352 may be prepared in a screen for the administrator 6. For example, various types of information such as a price category, an operator, a facility, a holiday, a ticket classification, a ticket group, an option group, and a ticket may be registered as master information.

The ticket listing screen for management 350 may include graphical user interfaces (GUI) such as various icons and operation buttons for accepting operations such as generation, update, duplication, and deletion of ticket information. For example, for each ticket, the ticket listing screen for management 350 displays a ticket list including information such as a ticket name, an operator of business entity, a name of a usable option group, a memorandum, information indicating before sale or on sale, a sale starting date, and a sale ending date. The ticket information may be read (imported) from a file by specifying the file name and may be saved (exported) into a file.

When an edit icon 354 under ticket operation in the ticket listing screen for management 350 in FIG. 21 is depressed, the screen makes a transition to a ticket editing screen for management 360 in FIG. 22, and detailed information of the ticket information can be set. FIG. 22 illustrates a screen example related to “(1) basic setting” and “(2) display” out of a plurality of setting items described below.

Examples of an item and a UI that are settable by the setting unit 112 include the following but are not limited thereto.

### (1) Basic Setting

A plurality of ticket sales patterns are selectable by checkboxes from (a) selectable as a main ticket, (b) selectable as an optional ticket, (c) a package ticket, and (d) a set ticket.

Furthermore, a function of a ticket can be specified between (a) a free ticket and (b) a coupon ticket by a radio button. When a free ticket is specified, a usable period (hours or days) can be further specified.

A set ticket is a free ticket attached to a main ticket or an optional ticket as a set, examples of the set ticket including a parking ticket and a coupon allowing receipt of a souvenir or benefits at a specific facility.

A package ticket is a package putting a plurality of set tickets together and may be a main ticket or an optional ticket. For example, a package ticket is a special package limited to a specific period (such as the Golden Week holidays or a summer vacation).

### (2) Display

Input of information about each ticket to be displayed on a website can be accepted by a text box.

For example, (a) f or each ticket, the name of the ticket can be set. An expression in a language other than Japanese (such as English or Chinese) may be further set. Furthermore, (b) a description of each ticket, (c) a link to a use guide of the ticket, and (d) a link to a use guide can be set. Further, (e) upload of an animation file to be displayed on the ticket face of the ticket may be performed.

### (3) Use Start Method

A use start method for a ticket can be selected by a radio button among from (a) use starts by a QR reader, (b) use starts by depression of a button by a user, and (c) use starts by reading a QR on a facility.

### (4) Use Start Condition

Whether to specify an allowable use starting period of a ticket can be specified. For example, specification of a period can be specified by a checkbox. When specification of a period is specified, input of an allowable use starting period (such as a starting date and an ending date) to be specified is accepted by a text box, a pull-down menu, or the like.

### (5) Day of Week Specification

A day of the week when use of a ticket may start can be specified.

A plurality of items are selectable by checkboxes from among (a) use may start on a weekday (other than Saturday, Sunday, and a holiday), (b) use may start on Saturday, (c) use may start on Sunday, and (d) use may start on a holiday.

### (6) Time Specification

Whether to specify an allowable use starting period of a ticket by time can be specified. For example, specification by time can be specified by a checkbox. When specification by time is specified, input of an allowable use starting time (a starting time and an ending time) to be specified is accepted by a text box, a pull-down menu, or the like.

### (7) Use End Condition

A use end condition of a ticket can be specified as follows: (a) an expiration date can be specified by the number of days, and input of the number of days is accepted by a text box, a pull-down menu, or the like, (b) a unit of setting of an expiration date is selectable between hours and days by a radio button, (c) input of a usable period is accepted by a text box, a pull-down menu, or the like in a unit selected in (b), and (d) a use ending time (or business ending time) is accepted by a text box, a pull-down menu, or the like.

### (8) Price Information

(a) A plurality of operators of business entities of a ticket are selectable by checkboxes. For example, operators of transportation systems such as a railroad and a bus, and operators of tourist facilities previously undergo master registration as operator information in association with business entity codes. Operator names registered in the operator information are displayed in a list form, a checkbox is provided for each operator name, and selection is accepted.
(b) A distribution ratio between a plurality of operators of business entities is accepted by text boxes. In a case of a specially planned ticket using a plurality of transportation systems, facilities, and/or the like run by operators of different business entities, amount adjustment between the operators of business entities can be performed based on the preset distribution ratio.
(c) for each price category, (d) input of a price is accepted by a text box. Examples of the price category in (c) include adult, student, child, and license surrenderer only and may be preregistered as master information. A category related to a ticket can be specified from among preset price categories by a checkbox, and the price for the specified category can be input. (e) Whether a ticket is refundable can be specified by a checkbox. (f) Input of a refund fee of a ticket is accepted by a text box.

### (9) Option Group

Service information (optional ticket) that can be associated with a ticket can be specified. A list of registered option groups is separately displayed. Specification of service information associated with a ticket is accepted by selecting a checkbox provided for each option group. The list of option groups displays option group names and usable ticket names.

### (10) Set Ticket

Service information (set ticket) that can be associated with a ticket can be specified. A list of registered set tickets is separately displayed. Specification of a set ticket associated with a ticket is accepted by selecting a checkbox provided for each set ticket.

### (11) Others

Input of information such as a target area of a ticket, information about whether the ticket is a visually observed ticket, a sale starting date, and a sale ending date may be accepted by a text box.

The setting unit 112 stores the aforementioned several types of setting information of a ticket accepted on the setting screen into the ticket information 130 and the service information 140.

The setting unit 112 in the server 100 according to the present example embodiment accepts a setting of association of a ticket with a service information and stores the setting into the ticket information 130 and the service information 140. The configuration enables systematic management of tickets and service information sold or provided by operators of different businesses. Since the administrator 6 can freely perform setting on the setting screen by using the administrative console 60, excellent operability is provided, and an omission in a setting and an erroneous setting can be prevented.

While the example embodiments of the present invention have been described above with reference to the drawings, the example embodiments are exemplifications of the present invention, and various configurations other than those described above may be employed.

While the present invention has been described with reference to the example embodiments and the examples thereof, the present invention is not limited to the aforementioned example embodiments and examples thereof. Various changes and modifications that may be understood by a person skilled in the art may be made to the configurations and details of the present invention without departing from the scope of the present invention.

Note that, when information about a user is acquired and used in the present invention, the acquisition and the use are assumed to be performed legally.

The whole or part of the example embodiments disclosed above may also be described as, but not limited to, the following supplementary notes.
1. An information processing apparatus including:
   a storage control unit that causes a ticket to be stored in association with service information that can be received when the ticket is purchased; and
   a display control unit that causes a display unit to display a screen for accepting an operation by a user, wherein
   the display control unit
      causes the display unit to display a selection screen for accepting selection of the service information associated with the ticket when accepting selection of the ticket as a purchase target and
      computes a settlement amount of the selected service information and the selected ticket and causes the display unit to display a settlement amount screen, and,
   after completion of a settlement procedure for the settlement amount, the storage control unit causes the ticket and the service information for which the settlement procedure is completed to be stored in association with the user.
2. The information processing apparatus according to 1., wherein the service information includes a second ticket different from the ticket.
3. The information processing apparatus according to 2., wherein
   each of the tickets is associated with at least one of a term of validity and an allowable use count, and
   the information processing apparatus further includes a determination unit that, when the ticket is used, performs validity determination of the ticket by setting a starting time of the term of validity or counting the allowable use count.
4. The information processing apparatus according to 3., wherein,
   when the ticket is associated with the term of validity, an allowable time frame for a start of use of the ticket is set, and
   the determination unit further uses whether a current time is in an allowable time frame for the start of use of the ticket in the validity determination.
5. The information processing apparatus according to any one of 1. to 4., further including
   an acceptance unit that accepts a use start request for the ticket, wherein
   an acceptance method for the use start request is set for each of the tickets, and
   the acceptance unit accepts the use start request for the ticket by the acceptance method related to each of the tickets.
6. The information processing apparatus according to any one of 1. to 5., further including a setting unit that sets association between the ticket and the service information.
7. An information processing method including, by an information processing apparatus:
   causing a storage apparatus to store a ticket in association with service information that can be received when the ticket is purchased;
   causing a display unit to display a selection screen for accepting selection of the service information associated with the ticket when accepting selection of the ticket as a purchase target;
   computing a settlement amount of the selected service information and the selected ticket and causing the display unit to display a settlement amount screen; and,
   after completion of a settlement procedure for the settlement amount, causing the ticket and the service information for which the settlement procedure is completed to be stored in association with a user.
8. The information processing method according to 7., wherein the service information includes a second ticket different from the ticket.
9. The information processing method according to 8., wherein
   each of the tickets is associated with at least one of a term of validity and an allowable use count, and
   the information processing method further includes, by the information processing apparatus, when the ticket is used, performing validity determination of the ticket by setting a starting time of the term of validity or counting the allowable use count.
10. The information processing method according to 9., wherein,
   when the ticket is associated with the term of validity, an allowable time frame for a start of use of the ticket is set, and
   the information processing method further includes, by the information processing apparatus, further using whether a current time is in an allowable time frame for the start of use of the ticket in the validity determination.
11. The information processing method according to any one of 7. to 10., further including, by the information processing apparatus,
   accepting a use start request for the ticket, wherein
   an acceptance method for the use start request is set for each of the tickets, and
   the information processing method further includes, by the information processing apparatus, accepting the use start request for the ticket by the acceptance method related to each of the tickets.
12. The information processing method according to any one of 7. to 11., further including, by the information processing apparatus,
   setting association between the ticket and the service information.
13. A program for causing a computer to execute:
   a procedure for causing a storage apparatus to store a ticket in association with service information that can be received when the ticket is purchased;
   a procedure for causing a display unit to display a selection screen for accepting selection of the service information associated with the ticket when accepting selection of the ticket as a purchase target;
   a procedure for computing a settlement amount of the selected service information and the selected ticket and causing the display unit to display a settlement amount screen; and
   a procedure for, after completion of a settlement procedure for the settlement amount, causing the ticket and the service information for which the settlement procedure is completed to be stored in association with a user.
14. The program according to 13., wherein
   the service information includes a second ticket different from the ticket.
15. The program according to 14., wherein
   each of the tickets is associated with at least one of a term of validity and an allowable use count, and
   the program further causes the computer to execute a procedure for, when the ticket is used, performing validity determination of the ticket by setting a starting time of the term of validity or counting the allowable use count.
16. The program according to 15., wherein,
   when the ticket is associated with the term of validity, an allowable time frame for a start of use of the ticket is set, and,
   in a procedure for performing the validity determination, whether a current time is in an allowable time frame for the start of use of the ticket is further used in the validity determination.
17. The program according to any one of 13. to 16., further causing the computer to execute
   a procedure for accepting a use start request for the ticket, wherein
   an acceptance method for the use start request is set for each of the tickets, and,
   in a procedure for the acceptance, the use start request for the ticket is accepted by the acceptance method related to each of the tickets.
18. The program according to any one of 13. to 17., further causing the computer to execute
   a procedure for setting association between the ticket and the service information.

### REFERENCE SIGNS LIST

1 Digital ticketing system
2 Network
4 User
6 Administrator
8 Operator
10 User terminal
42 Touch panel
60 Administrative console
80 Work terminal
90 Code reader
100 Server
102 Storage control unit
104 Display control unit
106 Determination unit
110 Acceptance unit
112 Setting unit
120 Storage apparatus
130 Ticket information
140 Service information
150 Ticket purchase information
160 User account information
200 Menu screen
210 Ticket selection screen
220 Quantity specification screen
230 Next button
250 Option selection screen
280 Purchased ticket listing screen
286 History tab
290 Detailed ticket information display part
300 Detailed ticket screen
320 Use start screen
330 Ticket face screen
340 Ticket usage display part
350 Ticket listing screen for management
360 Ticket editing screen for management
1000 Computer
1010 Bus
1020 Processor
1030 Memory
1040 Storage device
1050 Input-output interface
1060 Network interface

What is claimed is:

1. An information processing apparatus comprising:
at least one memory configured to store instructions; and
at least one processor configured to execute the instructions to:
cause a ticket to be stored in association with service information that can be received when the ticket is purchased; and
cause a display unit to display a screen for accepting an operation by a user, wherein
the at least one processor is configured to execute the instructions to:
cause the display unit to display a selection screen for accepting selection of the service information associated with the ticket when accepting selection of the ticket as a purchase target and
compute a settlement amount of the selected service information and the selected ticket and causes the display unit to display a settlement amount screen, and,
after completion of a settlement procedure for the settlement amount, cause the ticket and the service information for which the settlement procedure is completed to be stored in association with the user.

2. The information processing apparatus according to claim 1, wherein
the service information includes a second ticket different from the ticket.

3. The information processing apparatus according to claim 2, wherein
each of the tickets is associated with at least one of a term of validity and an allowable use count, and
the at least one processor is further configured to execute the instructions to
when the ticket is used, perform validity determination of the ticket by setting a starting time of the term of validity or counting the allowable use count.

4. The information processing apparatus according to claim 3, wherein,
when the ticket is associated with the term of validity, an allowable time frame for a start of use of the ticket is set, and
the at least one processor is further configured to execute the instructions to
use whether a current time is in an allowable time frame for the start of use of the ticket in the validity determination.

5. The information processing apparatus according to claim 1, wherein the at least one processor is further configured to execute the instructions to
accept a use start request for the ticket, wherein
an acceptance method for the use start request is set for each of the tickets, and
the at least one processor is further configured to execute the instructions to
accept the use start request for the ticket by the acceptance method related to each of the tickets.

6. The information processing apparatus according to claim 1, wherein the at least one processor is further configured to execute the instructions to
set association between the ticket and the service information.

7. An information processing method comprising, by an information processing apparatus:
causing a storage apparatus to store a ticket in association with service information that can be received when the ticket is purchased;
causing a display unit to display a selection screen for accepting selection of the service information associated with the ticket when accepting selection of the ticket as a purchase target;
computing a settlement amount of the selected service information and the selected ticket and causing the display unit to display a settlement amount screen; and,
after completion of a settlement procedure for the settlement amount, causing the ticket and the service information for which the settlement procedure is completed to be stored in association with a user.

8. The information processing method according to claim 7, wherein
the service information includes a second ticket different from the ticket.

9. The information processing method according to claim 8, wherein
each of the tickets is associated with at least one of a term of validity and an allowable use count, and
the information processing method further comprises, by the information processing apparatus, when the ticket is used, performing validity determination of the ticket by setting a starting time of the term of validity or counting the allowable use count.

10. The information processing method according to claim 9, wherein,
when the ticket is associated with the term of validity, an allowable time frame for a start of use of the ticket is set, and
the information processing method further comprises, by the information processing apparatus, further using whether a current time is in an allowable time frame for the start of use of the ticket in the validity determination.

11. The information processing method according to claim 7, further comprising, by the information processing apparatus,
accepting a use start request for the ticket, wherein
an acceptance method for the use start request is set for each of the tickets, and
the information processing method further includes, by the information processing apparatus, accepting the use start request for the ticket by the acceptance method related to each of the tickets.

12. The information processing method according to claim 7, further comprising, by the information processing apparatus,
setting association between the ticket and the service information.

13. A non-transitory computer-readable storage medium storing a program for causing a computer to execute:
a procedure for causing a storage apparatus to store a ticket in association with service information that can be received when the ticket is purchased;
a procedure for causing a display unit to display a selection screen for accepting selection of the service information associated with the ticket when accepting selection of the ticket as a purchase target;
a procedure for computing a settlement amount of the selected service information and the selected ticket and causing the display unit to display a settlement amount screen; and
a procedure for, after completion of a settlement procedure for the settlement amount, causing the ticket and the service information for which the settlement procedure is completed to be stored in association with a user.

14. The non-transitory computer-readable storage medium according to claim 13, wherein
the service information includes a second ticket different from the ticket.

15. The non-transitory computer-readable storage medium according to claim 14, wherein
each of the tickets is associated with at least one of a term of validity and an allowable use count, and
the program further causes the computer to execute a procedure for, when the ticket is used, performing validity determination of the ticket by setting a starting time of the term of validity or counting the allowable use count.

16. The non-transitory computer-readable storage medium according to claim 15, wherein,
when the ticket is associated with the term of validity, an allowable time frame for a start of use of the ticket is set, and,
in a procedure for performing the validity determination, whether a current time is in an allowable time frame for the start of use of the ticket is further used in the validity determination.

17. The non-transitory computer-readable storage medium according to claim 13, wherein the program further causes the computer to execute
a procedure for accepting a use start request for the ticket, wherein
an acceptance method for the use start request is set for each of the tickets, and,
in a procedure for the acceptance, the use start request for the ticket is accepted by the acceptance method related to each of the tickets.

18. The non-transitory computer-readable storage medium according to claim 13, wherein the program further causes the computer to execute
a procedure for setting association between the ticket and the service information.
